(19) United States
(12) Patent Application Publication
(10) Pub. No.: US 2025/0173608 A1
(43) Pub. Date: May 29, 2025

(54) SYSTEM AND METHOD FOR ARTIFICIAL INTELLIGENCE AND MACHINE LEARNING MODEL VALIDATION

(71) Applicant: FAIRLY AI INC., Kitchener (CA)

(72) Inventors: David VAN BRUWAENE, Kitchener (CA); Stuart MAIDEN, Kitchener (CA); Nikola GRADOJEVIC, Kitchener (CA)

(21) Appl. No.: 18/695,305

(22) PCT Filed: Sep. 27, 2022
(86) PCT No.: PCT/CA2022/000053

§ 371 Date: Mar. 25, 2024

Related U.S. Application Data
(60) Provisional application No. 63/248,933, filed on Sep. 27, 2021.

(51) Int. Cl. G06N 20/00

(52) U.S. Cl. CPC G06N 20/00

(57) ABSTRACT

What is disclosed is: A method for artificial intelligence comprising: receiving, by an artificial intelligence validation system, qualitative and quantitative information within one or more incoming signals; extracting, by at least one of a communications subsystem and an application engine within the artificial intelligence validation system, the quantitative and qualitative information from the one or more incoming signals; receiving, by one or more validation processing subsystems within the artificial intelligence validation system, the qualitative and quantitative information; comparing at least one of the quantitative and qualitative information to one or more benchmarks, generating one or more microapprovals using one or more artificial intelligence or machine learning algorithms based on the comparing; and transmitting the generated one or more microapprovals.

### CROSS-REFERENCE TO RELATED APPLICATIONS

The present applicant claims the priority benefit of U.S. Provisional Application 63/248,933, filed on Sep. 27, 2021, the entire contents of which are incorporated herein by reference.

### FIELD OF THE INVENTION

The present disclosure relates to artificial intelligence (AI) and machine learning (ML) model development, validation and de-biasing.

### BACKGROUND

In artificial intelligence (AI) and machine learning (ML) development environments, often the model development teams are separated from the validation teams. This separation can present drawbacks to developing and validating AI and ML algorithms.

### BRIEF SUMMARY

A system for artificial intelligence models comprising: an artificial intelligence validation system coupled to a network, wherein the artificial intelligence validation system comprises a back end comprising one or more validation processing subsystems, a database, further wherein the validation processing subsystem is communicatively coupled to the database via one or more interconnections; a front end comprising an application engine, and a communications subsystem, further wherein the communications subsystem and the application engine are communicatively coupled to the back end via the one or more interconnections, the communications subsystem is communicatively coupled to the application engine, and the communications subsystem is communicatively coupled to the network to receive one or more incoming signals from and transmit one or more outgoing signals to the network, wherein the one or more incoming signals comprise one or more of qualitative and/or quantitative information; at least one of the communications subsystem and the application engine extracts the quantitative and/or qualitative information within the one or more incoming signals; the one or more validation processing subsystems receives the qualitative and/or quantitative information from at least one of the communications subsystem and the application engine via the one or more interconnections; the one or more validation processing subsystems uses at least one of the quantitative and/or qualitative information to perform comparisons to one or more benchmarks; the one or more validation processing subsystems generates one or more microapprovals based on the comparisons, and wherein the generation of the one or more microapprovals is performed using one or more artificial intelligence or machine learning operations; and the one or more validation processing subsystems transmits, via the communications subsystem and the application engine, the microapprovals using the one or more outgoing signals.

A method for artificial intelligence comprising: receiving, by an artificial intelligence validation system, one or more qualitative and/or quantitative information within one or more incoming signals; extracting, by at least one of a communications subsystem and an application engine within the artificial intelligence validation system, the quantitative and/or qualitative information from the one or more incoming signals; receiving, by one or more validation processing subsystems within the artificial intelligence validation system, the qualitative and/or quantitative information; comparing, by the one or more validation processing subsystems, at least one of the quantitative and/or qualitative information to one or more benchmarks, generating, by the one or more validation processing subsystems, one or more microapprovals based on the comparing, wherein the generation of the one or more microapprovals is performed using one or more artificial intelligence or machine learning operations; and transmitting, by the one or more validation processing subsystems, the generated one or more microapprovals.

A system for providing an escrow service for artificial intelligence (AI) model development and validation, the system comprising: an artificial intelligence validation system coupled to a network, wherein the artificial intelligence validation system comprises a back end further comprising one or more validation processing subsystems, and a database, further wherein the one or more validation processing subsystems are communicatively coupled to the database via one or more interconnections, a front end comprising an application engine, and a communications subsystem, further wherein the communications subsystem and the application engine are communicatively coupled to the back end via the one or more interconnections, the communications subsystem is communicatively coupled to the application engine, and the communications subsystem is communicatively coupled to the network to receive one or more incoming signals and transmit one or more outgoing signals from the network; further wherein a first information intended for escrow are input to the one or more validation processing subsystems, a second information intended for escrow are input to the one or more validation processing subsystems, an analysis is performed by the one or more validation processing subsystems using the first information intended for escrow and the second information intended for escrow, wherein the analysis comprises one or more artificial intelligence or machine learning operations, and one or more outputs are generated based on the analysis, and the one or more outputs from the analysis.

A method for operating an escrow service to validate an artificial intelligence (AI) model comprising: receiving from, one or more first party devices, a first information intended for escrow to one or more validation processing subsystems; receiving, from one or more second party devices, a second information intended for escrow to the one or more validation processing subsystems; and performing, by the one or more validation processing subsystems, an analysis using the first information intended for escrow and the second information intended for escrow, wherein the analysis comprises one or more artificial intelligence or machine learning operations, one or more outputs are generated based on the analysis, and transmitting, the one or more outputs from the analysis, to at least one of the one or more first party and one or more second party devices, wherein at least some first information is not included in any output to the one or more second party devices, and at least some second information is not included in any output to the one or more first party devices.

The foregoing and additional aspects and embodiments of the present disclosure will be apparent to those of ordinary skill in the art in view of the detailed description of various embodiments and/or aspects, which is made with reference to the drawings, a brief description of which is provided next.

### BRIEF DESCRIPTION OF THE DRAWINGS

The foregoing and other advantages of the disclosure will become apparent upon reading the following detailed description and upon reference to the drawings.

FIG. 1 is an illustration of a system for improved communications and workflow between development and validation teams.

FIG. 2 is an illustration of an example embodiment of a development device.

FIG. 3 is an illustration of a detailed embodiment of an artificial intelligence (AI) validation system.

FIG. 4 is an illustration of an example embodiment of a process for AI model validation and de-biasing.

FIG. 5A is an illustration of an example embodiment of an escrow service.

FIG. 5B is an illustration of an example embodiment of an escrow implementation system.

FIG. 6 is an illustration of an example embodiment of a sensitive feature escrow service subsystem.

FIG. 7 is an illustration of an example embodiment of a subsystem for remote escrow-data-driven adversarial de-biasing.

While the present disclosure is susceptible to various modifications and alternative forms, specific embodiments or implementations have been shown by way of example in the drawings and will be described in detail herein. It should be understood, however, that the disclosure is not intended to be limited to the particular forms disclosed. Rather, the disclosure is to cover all modifications, equivalents, and alternatives falling within the spirit and scope of an invention as defined by the appended claims.

### DETAILED DESCRIPTION

As stated in the background, in artificial intelligence (AI) and machine learning (ML) development environments, often the model development teams are separated from the validation teams.

Model validation is an important and necessary part of model risk management within many industries. For example, the Board of Governors of the United States Federal Reserve System or “the Fed” issued Supervision and Regulation Letter 11-7: Guidance on Model Risk Management, published Apr. 4, 2011, retrieved on Jul. 15, 2021 from https://www.federalreserve.gov/supervisionreg/srletters/sr1107.htm. Supervision and Regulation Letter 11-7 (SR 11-7) provides a framework for model risk management which is tried and tested in well-resourced environments. SR 11-7 covers many possible types of risk, including financial risk and reputational risk. While it is more applicable to quantitative finance or “quant” models, the Fed is updating the SR11-7 framework to include AI and ML-based models as well. In addition, while SR 11-7 covers many possible types of risk, it may not be able to cover all potential sources of risk. For example, SR 11-7 may not cover model risk, as model risk may arise on a broader scale outside the expectations and assumptions of regulatory standards such as SR 11-7.

AI and ML-based models pose specific challenges in terms of risk. For example, issues such as the usage of biased data sets for training have led, and may continue to lead to ethical, financial and reputational risk. Current model validation approaches involve the development teams sending the model and lengthy reports to the validation teams. The validation teams then have to rebuild the models from the “ground up”, which is time consuming. Furthermore, in the case of models which are being continuously updated to take into account, for example, new features or which use new algorithms, the validation process can be even more time consuming.

In addition to risk management, there is also a need to facilitate the implementation of policy for AI and ML-based models. These policies either comprise or can be based on, for example:
regulatory requirements, for example, the US Fair Lending Act, the European Union (EU) General Data Protection Regulation (GDPR) and the proposed EU AI regulations;
standards-based requirements, for example, International Organization for Standardization (ISO) standards requirements or the Institute for Electrical and Electronics Engineers (IEEE) standards requirements;
industry best practices;
internal business policies; and
implementation of ethical principles;

Then there is a need for AI and ML model validation against these policies.

Furthermore, people from different parts of an organization, or from different organizations have a need to exchange information, data and programs for testing, validation and evaluation with each other, without submitting the actual information, data and programs to the other party.

For example, a first department in an organization may want to test and validate a second department's AI/ML models with their data prior to use, but does not want to or be allowed to share their data with the second department. Similarly, the second department may want to use the first department's data for their models, but may not want to or be allowed to share their models with the first department. This inability or reluctance could arise due to, for example, rules or policies. Then, a neutral internal escrow system or service that receives the data from the first department and the models from the second department and performs necessary testing, validation and analyses can resolve such deadlocks and reduce the resulting delays.

Another example is as follows: Development and validation teams within the same organization are separated from each other due to, for example, rules or policies. The validation team may then need to evaluate a model created by the development team, but communication with the development team is limited due to the aforementioned policies. Then, the neutral internal escrow system or service described above allows both teams to perform tasks while maintaining a requisite level of separation.

Yet another example is as follows: When a purchaser wants to purchase AI/ML services from a vendor, the purchaser has a need to test and validate the vendor's models and programs prior to purchase. However, the purchaser does not want to share data with the vendor. Similarly, the vendor may be interested in selling AI/ML services to the purchaser, but does not want to share details and sensitive intellectual property (IP) about the AI/ML models used to provide those services. This can lead to long delays, as both sides need to build up trust in each other before any exchanges can take place. Therefore, there is a need for a third-party remote escrow service where purchasers and vendors can submit data and models respectively, but neither side is able to view either the data or models. Having such a service can help reduce delays and trust issues.

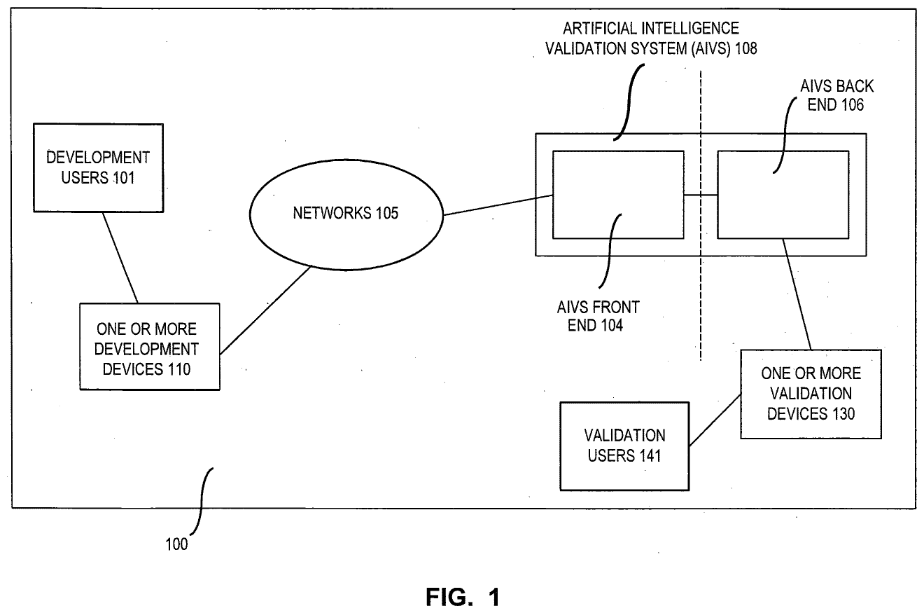

A system and method to enable improved efficiency in communications and workflow management between the development team and the validation team is presented in FIG. 1, as well as to implement fairness, risk evaluation, bias detection, monitoring and mitigation and de-biasing is presented in FIG. 1. As will be described further below, in some embodiments this system is used to provide an escrow service which could be internal or remote. In FIG. 1, in system 100, one or more development devices 110 are coupled to networks 105.

One or more development devices 110 are associated with development users 101. Development users 101 are, for example, part of a development team. These include, for example, smartphones, tablets, laptops, desktops or any appropriate computing and network-enabled device used for AI or ML model development. In some embodiments, one or more development devices 110 are communicatively coupled to networks 105 so as to transmit communications to, and receive communications from networks 105. One or more development devices 110 are coupled to the other components of system 100 via networks 105.

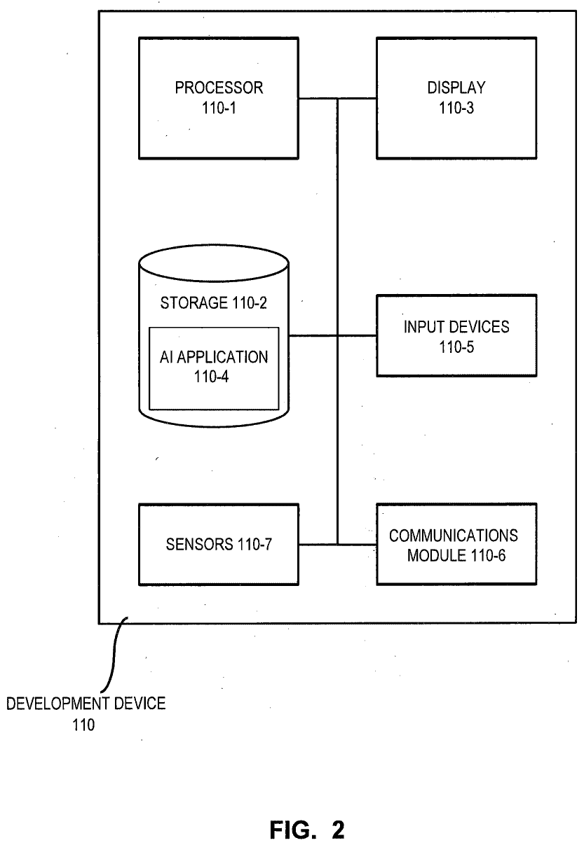

An example embodiment of one of the one or more development devices 110 is shown in FIG. 2. In FIG. 2, processor 110-1 performs processing functions and operations necessary for the operation of one of the one or more development devices 110, using data and programs stored in storage 110-2. An example of such a program is AI/ML application 110-4, which will be described in further detail below. Display 110-3 performs the function of displaying data and information for user 101. Input devices 110-5 allow one of the development users 101 to enter information. This includes, for example, devices such as a touch screen, mouse, keypad, keyboard, microphone, camera, video camera and so on. In some embodiments, display 110-3 is a touchscreen which means it is also part of input devices 110-5. Communications module 110-6 allows user device 110 to communicate with devices and networks external to user device 110. This includes, for example, communications via BLUETOOTH®, Wi-Fi, Near Field Communications (NFC), Radio Frequency Identification (RFID), 3G, Long Term Evolution (LTE), Universal Serial Bus (USB) and other protocols known to those of skill in the art. Sensors 110-7 perform functions to sense or detect environmental or locational parameters. Sensors 110-7 include, for example, accelerometers, gyroscopes, magnetometers, barometers, Global Positioning System (GPS), proximity sensors and ambient light sensors. The components of user device 110 are coupled to each other as shown in FIG. 2.

AI application 110-4 is, for example, where the development users 101 work on various AI and ML models to perform activities such as learning or training, testing, and model development. As will be explained below, these AI models are validated as necessary.

While the above shows AI application 110-4 stored in storage 110-2, one of skill in the art would recognize that AI application 110-4 can be provided to development device 110 in many ways. In some embodiments, a Software as a Service (SaaS) delivery mechanism is used to deliver AI application 110-4 to the user. For example, in some embodiments the user activates a browser program stored in storage 110-2 and goes to a Uniform Resource Locator (URL) to access AI application 110-4.

In some embodiments, similar to the development devices 110 associated with the development users 110, one or more validation devices 130 are associated with validation users 141. Validation users 141 are, for example, part of a validation team. Examples of validation teams include, for example, teams tasked with performing fair lending analysis. As explained above, the development teams are often kept separate from the validation teams. This is implemented using, for example, a firewall or other techniques known to those of skill in the art. Examples of validation devices include, for example, laptops, desktops, servers, smartphones, tablets or any appropriate computing and network-enabled device used for AI model validation. In some embodiments, validation devices 130 have a similar structure to the structure of development device 110 shown in FIG. 2.

Networks 105 plays the role of communicatively coupling the various components of system 100. Networks 105 can be implemented using a variety of networking and communications technologies. In some embodiments, networks 105 are implemented using wired technologies such as Firewire, Universal Serial Bus (USB), Ethernet and optical networks. In some embodiments, networks 105 are implemented using wireless technologies such as WiFi, BLUETOOTH®, NFC, 3G, LTE and 5G. In some embodiments, networks 105 are implemented using satellite communications links. In some embodiments, the communication technologies stated above include, for example, technologies related to a local area network (LAN), a campus area network (CAN) or a metropolitan area network (MAN). In yet other embodiments, networks 105 are implemented using terrestrial communications links. In some embodiments, networks 105 comprise at least one public network. In some embodiments, networks 105 comprise at least one private network. In some embodiments, networks 105 comprise one or more subnetworks. In some of these embodiments, some of the subnetworks are private. In some of these embodiments, some of the subnetworks are public. In some embodiments, communications within networks 105 are encrypted.

In FIG. 1 artificial intelligence validation system (AIVS) 108 is coupled to network 105. In FIG. 1, AIVS 108 has a front-end 104 and a back-end 106. Front-end 104 is coupled to one or more development devices 110 via network 105. Back end 106 is coupled to front-end 104 as shown above. Back end 106 is also coupled to one or more validation devices 130.

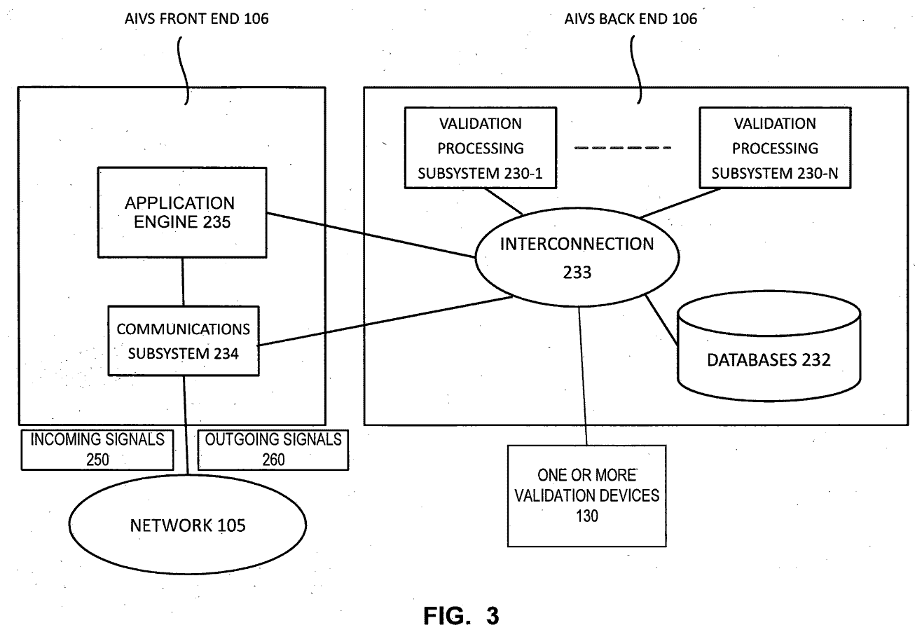

A detailed embodiment of AIVS 108 is shown in FIG. 3. AIVS 108 performs analysis of AI models for validation purposes. In FIG. 3, AIVS front-end 104 is comprised of application engine 235 and communications subsystem 234. Communications subsystem 234 is coupled to network 105. Communications subsystem 234 receives information from, and transmits information to network 105. Communications subsystem 234 can communicate using the communications and networking protocols and techniques that network 105 utilizes. Communications subsystem 234 receives information from network 105 within, for example, incoming signals 250; and transmits information to network 105 within, for example, outgoing signals 260.

Application engine 235 is coupled to communications subsystem 234 and the AIVS back-end components via interconnections 233. Application engine 235 is also coupled to network 105 via communications subsystem 234. Application engine 235 facilitates interactions with one or more development devices 110 via network 105 such as opening up application programming interfaces (APIs) with the one or more development devices; and generating and transmitting queries to the one or more development devices 110.

Databases 232 stores information and data for use by AIVS 108. This includes, for example:
one or more algorithms and programs necessary to perform validation, and
other data as needed.

In one embodiment, database 232 further comprises a database server. The database server receives one or more commands from, for example, validation processing subsystem 230-1 to 230-N and communication subsystem 234, and translates these commands into appropriate database language commands to retrieve and store data into databases 232. In one embodiment, database 232 is implemented using one or more database languages known to those of skill in the art, including, for example, Structured Query Language (SQL). In a further embodiment, database 232 stores data for a plurality of sets of development users. Then, there may be a need to keep the set of data related to each set of development users separate from the data relating to the other sets of development users. In some embodiments, databases 232 is partitioned so that data related to each test subject is separate from the other sets of development users. The development users then need to authenticate themselves so as to access information related to their particular data sets. In a further embodiment, when data is entered into databases 232, associated metadata is added so as to make it more easily searchable. In a further embodiment, the associated metadata comprises one or more tags. In yet another embodiment, database 232 presents an interface to enable the entering of search queries. Further details of this are explained below. In some embodiments databases 232 comprises a transactional database. In other embodiments, databases 232 comprise a multitenant database.

Validation processing subsystems 230-1 to 230-N perform processing, analysis and other operations, functions and tasks within AIVS 108 using one or more algorithms and programs; and data residing on AIVS 108. These algorithms and programs and data are stored in, for example:
database 232 as explained above, or
within validation processing subsystems 230-1 to 230-N.

Examples of processing, analysis and other operations performed by validation processing subsystem 230-1 to 230-N comprise:
pre-processing, for example, pre-processing of data sets to remove biases in the data sets;
risk assessment and detection, including generation of intelligent risk/quality indicators;
operations related to ensuring conformity of AI and ML models to policies;
auditing operations, including, for example, audit trail generation;
explainability analysis;
operations related to data drift detection;
operations related to testing for data integrity;
operations related to data and model robustness detection and mitigation;
operations related to privacy tests;
operations related to detection of data poisoning;
bias scanning and detection;
implementation of features necessary to run an escrow service;
bias mitigation or de-biasing, for example,
   bias mitigation techniques, such as data-driven adversarial de-biasing, and
   post-processing to remove detected biases;
upsampling and downsampling;
generation of reports for both validation and development teams, the reports comprising, for example:
   results from various tests and analyses performed, such as bias and fairness results,
   information associated with the data sets, and
   model metadata.
management of workflows between validation and development teams;
management of segregation of validation and development teams;
generation of notifications;
sensitivity and stability stress testing of models;
operations related to determining the soundness of a model operating in various contexts;
providing editing and editor functionalities; and
providing functionalities relating to generation of chats and comments;
   which will be explained in further detail below. In some embodiments, validation processing subsystem 230-1 to 230-N implement a risk engine which performs the risk-related tasks outlined above.

In some embodiments, at least some of the above operations are performed within an internal or remote escrow service, as will be explained below.

In some embodiments, validation processing subsystem 230-1 to 230-N respond to commands provided by validation devices 130 by the validation users. As shown in FIG. 3, validation devices 130 are coupled to the validation processing subsystem 230-1 to 230-N and databases 232 via, for example interconnection 233. Then, based on the commands provided by validation devices 130, validation processing subsystem perform the processing and analysis explained above.

In yet other embodiments, validation processing subsystems 230-1 to 230-N are implemented using, for example, multitenant implementations known to those of skill in the art. This enables multiple teams to share the resources of validation processing subsystems 230-1 to 230-N.

In some embodiments, some portion of at least one of the operations and functions described above are performed by application engine 235. In yet other embodiments, some portion of at least one of the operations and functions described above are performed by AI application 110-4.

Interconnection 233 connects the various components of AIVS 108 to each other. In one embodiment, interconnection 233 is implemented using, for example, network technologies known to those in the art. These include, for example, wireless networks, wired networks, Ethernet networks, local area networks, metropolitan area networks and optical networks. In one embodiment, interconnection 233 comprises one or more subnetworks. In another embodiment, interconnection 233 comprises other technologies to connect multiple components to each other including, for example, buses, coaxial cables, USB connections and so on.

Various implementations are possible for AIVS 108 and its components. In one embodiment, AIVS 108 is implemented using a cloud-based approach. In some of these embodiments where AIVS 108 is implemented using a cloud-based approach, Kubernetes-based approaches are used. An example of a Kubernetes-based approach is an approach which uses GOOGLE® Kubernetes Engine. In another embodiment, AIVS 108 is implemented across one or more facilities, where each of the components are located in different facilities and interconnection 233 is then a network-based connection. In a further embodiment, AIVS 108 is implemented within a single server or computer. In yet another embodiment, AIVS 108 is implemented in software. In another embodiment, AIVS 108 is implemented using a combination of software and hardware.

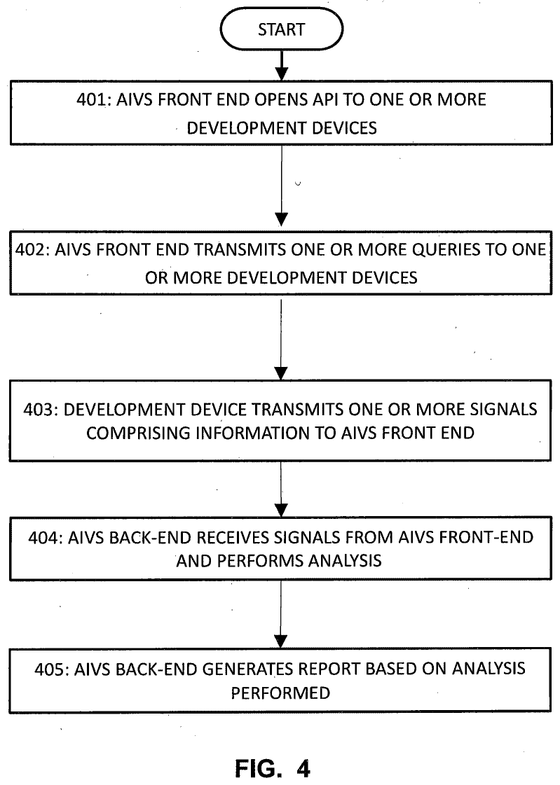

An example process for AI model validation and de-biasing is shown in FIG. 4, and is explained below with reference to FIGS. 1-3, 5 and 6.

In step 401, the application engine 235 within AIVS front-end 104 couples to the one or more development devices 110 via network 105 and communications subsystem 234. In some embodiments, this coupling comprises AIVS front-end 104 opening up an application programming interface (API) to one or more development devices 110 via network 105 and communications subsystem 234. In some embodiments, this is performed using AI application 110-4 stored in storage 110-2 of one or more development devices 110. In other embodiments, this is performed using a browser program stored in storage 110-2 of one or more development devices 110 to enable a SaaS implementation.

In step 402, the application engine 235 within AIVS front-end 104 transmits one or more queries to the one or more development devices 110 via network 105 via, for example, outgoing signals 260. This occurs, for example, via the previously opened API. These queries are directed towards finding information about how an AI model present on the development device 110 was developed. In some embodiments, the AI models are stored or developed using AI application 110-4, and the queries are presented to the development user via AI application 110-4. In some embodiments, the qualitative information is returned by a user via, for example, a questionnaire presented to the user. In some of these embodiments, the questionnaire is presented to the user via AI application 110-4.

In step 403, the one or more development devices 110 transmits one or more signals comprising information to communications subsystem 234 in AIVS front end 104 via networks 105. An example of the transmitted one or more signals is incoming signals 250. The information comprises quantitative information such as
test data sets, test data labels, training data sets, training data labels, and parameters;
configuration files,
tags,
metadata, and
associated other information.

Examples of tags comprise:
accuracy score,
recall score,
precision score,
disparate impact,
equalized odds,
bin width,
confusion matrix,
F1 score,
Receiver Operating Characteristic (ROC) curve,
area under the curve (AUC) score,
mean squared error,
mean absolute error,
confusion matrix,
true positive rate,
false positive rate,
r squared, and
adjusted r squared.

In some embodiments, fuzzy logic models are implemented. In fuzzy logic models, category selection together with an accuracy score and financial loss prediction analysis is performed. Then, in these models, risk classifications drawing on quantitative information are included in the configuration file.

In some embodiments, the information comprises qualitative information inputted by the users, for example, the decision data which led to the creation and validation of the ML or AI model.

For example, when a decision to take income data and place it into bins is made, other decision data can be inputted, such as whether the bin is constructed in accordance with certain specifications.

In some embodiments, step 403 comprises returning a Uniform Resource Locator (URL) where quantitative information such as a data set or qualitative information is stored. In step 404, the AIVS front-end 104 extracts, using at least one of the communications subsystem and the application engine, the quantitative and qualitative information within the one or more incoming signals. At least one of the communications subsystem 234 and application engine 235 in AIVS front-end 104 transmits the quantitative and qualitative information to at least one of one or more validation processing subsystems 230-1 to 230-N and database 232 in AIVS back-end 106 via, for example, interconnections 233. One or more validation processing subsystems 230-1 to 230-N then performs one or more of the processing, analysis and the other operations explained above. In some embodiments, as explained previously, at least one of the one or more operations are performed by the validation processing subsystems 230-1 to 230-N together with the application engine 235.

In some embodiments, one or more benchmarks are built to perform the analysis of the model. In some of these embodiments, in order to approve the entire model, it is necessary to obtain a microapproval for each of these one or more benchmarks.

In some of these embodiments, the one or more benchmarks are built by validation processing subsystems 230-1 to 230-N based on inputs supplied from one or more validation devices 130. In some embodiments, the one or more benchmarks are built using at least one of tags and the metadata within the received quantitative information. In other embodiments, the one or more benchmarks are generated in accordance with policies. Different types of policies were previously described. Then, at least one of the qualitative and quantitative data is compared against the one or more created benchmarks as part of performance monitoring.

Benchmarks can be built in various ways. In some embodiments, benchmarks are built based on a minimum performance requirement. In other embodiments, the benchmarks are built based on statistical measures such as means or medians. In yet other embodiments, benchmarks are built based on one or more thresholds.

Different types of analyses can be performed using the benchmarks. An example of such an analysis is an explainability analysis. In an explainability analysis, the human decisions which led to the creation of the model are analyzed. Some questions asked include:
which inputs are the most important in making a decision?
what is the sensitivity of input features towards the predicted result?
which of those are legally protected results?
has bias been reduced so that it meets the benchmark?

In some embodiments, the explainability analysis comprises performing a local and global explainability analysis. A local explainability analysis concerns analysis of issues for one customer, for example, answering questions such as why did a model make a mistake in a single case for a customer. A global explainability analysis concerns explainability analysis for all customers, or an overall model on a global level. For example, why are higher interest rates are being provided to a certain gender?

In other embodiments, a bias scanning analysis is performed. This comprises, for example:
receiving a data set from AIVS front-end 104 via, for example, incoming signals 250;
building, by validation processing subsystems 230-1 to 230-N, baseline models for comparison; and
performing analysis to detect whether the data set is biased by comparison against the baseline models using the benchmarks.

In yet other embodiments, analyses to determine conformity to policies are performed, based on the one or more benchmarks. In some embodiments, the analyses are performed to not only test individual technical measures against policies, but of many measures taken together to establish overall compliance against larger and more complex policies.

In yet other embodiments, step 404 comprises the performance of re-sampling or re weighting operations so as to correct biases within data sets.

Each time a benchmark is met, a microapproval is issued by one or more validation processing subsystems 230-1 to 230-N. Accordingly, in some examples, each microappoval is associated with a corresponding one or more benchmarks. Only when all the requisite benchmarks are met, then an overall approval is generated. In this way, it enables easier determination of the benchmarks which have not been met, and requirements for improvement or rectification; compared to a process which only generates an overall approval when all benchmarks are met.

In at least one example, the system includes a record of all target microapprovals required to be met, in order to generate an overall approval. For example, this can be an itemized list of the target microapprovals to generate the overall approval. In this example, the system can be a stateful system, whereby a record of the state of each microapproval is maintained. For instance, each microapproval may have one of two states: (i) a “non-issued” stated, and (ii) an “issued” state. If one or more benchmarks—corresponding to a microapproval—are satisfied, the state of that microapproval is modified to an issued state. Otherwise, the microapproval remains in the “non-issued” state. The system monitors if all target microapprovals have been assigned an “issued” state. Once all target microapprovals are “issued”, the system generates the overall approval.

In further embodiments, the validation processing subsystems 230-1 to 230-N implement one or more AI/ML algorithms to automate the process of generating microapprovals and overall approvals. For example, the validation processing subsystems 230-1 to 230-N perform training based on historical datasets stored on databases 232. Then, the validation processing subsystems 230-1 to 230-N use the results of the training to determine whether microapprovals should be generated.

For added clarity, microapprovals may be generated using machine learning model(s), separate from the machine model(s) escrowed by the system. The microappoval machine learning (ML) models are trained to automatically generate predicted output states for microapprovals. For instance, the trained models can estimate whether a microapproval is “issued” based on factors analyzed for different benchmarks, as described above. The microappoval machine learning models can be trained, for example, using known supervised or unsupervised learning techniques. In at least one example, the microapproval ML models are trained using training datasets, comprising historical datasets of previously issued microapprovals (and/or non-issued microapprovals), and the corresponding factors considered in evaluating the corresponding benchmarks for that microapproval.

In some examples, a separate machine learning model is trained for each separate microapproval. Accordingly, in applying the machine learning models, the system (i) selects the trained model corresponding to that microapproval; and (ii) applies the selected model to generate a predicted state output for that microapproval.

The described embodiments therefore allows an improvement over prior processes, as automation allows for continuous monitoring of AI/ML models with reduced or eliminated need for human intervention. Continuous monitoring allows for continuous automated generation of microapprovals and overall approvals related to AI/ML models, which leads to a more efficient and less time-consuming development process. This leads to other potential advantages, for example, faster and more efficient model development.

In some embodiments, the analyses above are performed by the validation processing subsystems 230-1 to 230-N in response to commands and inputs supplied from validation devices 130. That is, validation devices 130 control the operation of validation processing subsystems 230-1 to 230-N to perform the analyses above.

As explained above, there is a need for an escrow service which is either internal or remote. Such an escrow service allows for two groups to perform testing or validation while maintaining a requisite level of separation from each other.

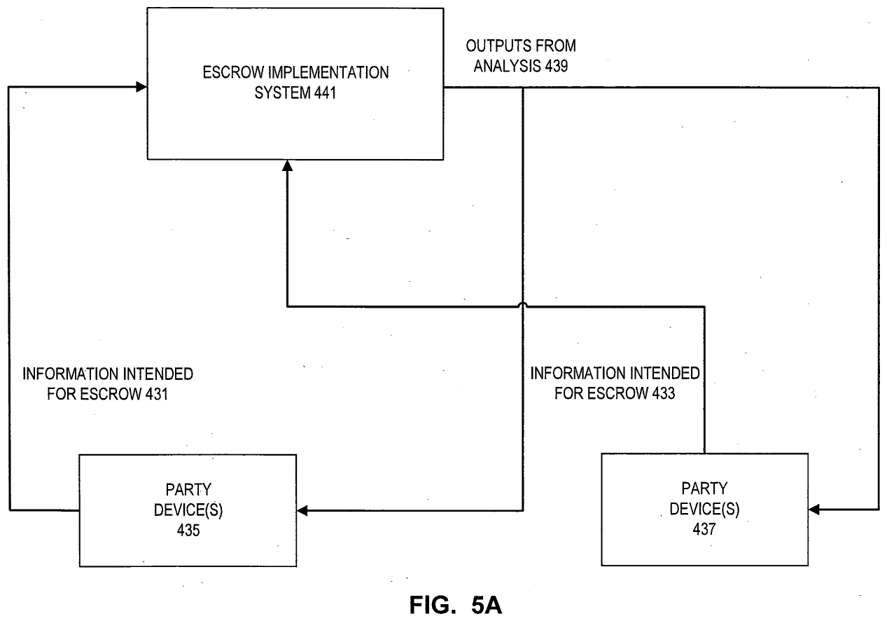

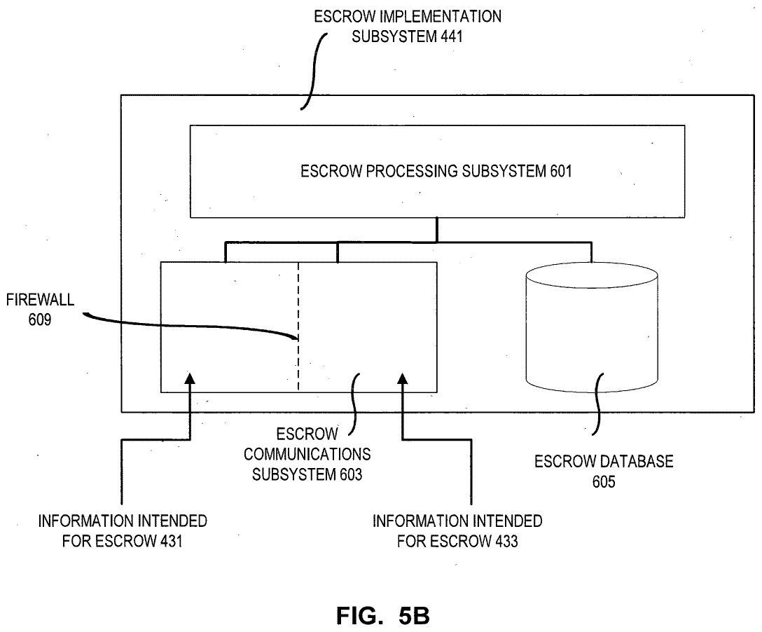

FIGS. 5A and 5B show an example embodiment of a system to implement such an escrow service. In FIG. 5A, escrow implementation system 441 implements an escrow service. In some embodiments, as will be detailed below, escrow implementation system 441 is implemented as part of AIVS 108.

Referring to FIG. 5A, party device(s) 435 are communicatively coupled to escrow implementation system 441, and submit information intended for escrow 431 to escrow processing subsystem 441. Party device(s) 437 are communicatively coupled to escrow implementation system 441, and submit information intended for escrow 433 to escrow processing subsystem 441. Party device(s) 435, 437 may be referred to herein throughout simply as “parties” 435, 437, respectively.

Parties 435 and 437 are, for example,
computing device(s) associated with a purchaser and a vendor; or
computing device(s) associated with two different parts of an organization.

In some of the embodiments where escrow implementation system 441 is implemented as part of AIVS 108, parties 435 and 437 comprise one or more development devices 110 or one or more validation devices 130.

In some of these embodiments where escrow implementation system 441 is implemented as part of AIVS 108, parties 435 and 437 are coupled to either network 105 of FIG. 1 or interconnection 233 of FIG. 3 as previously described, so as to enable the submissions to occur from the parties 435 and 437.

Information intended for escrow 431 and information intended for escrow 433 comprise, for example:
sensitive features for AI/ML models, which will be explained in further detail below;
test data for AI/ML models;
test labels for AI/ML models;
intellectual property (IP) such as trade secrets; and
other sensitive or confidential information between multiple parties in contexts of use such as internal and external audit, procurement, and ongoing monitoring of models once sold or put in use with outside organizations and entities.

FIG. 5B shows a detailed embodiment of escrow implementation subsystem 441. In FIG. 5B, escrow implementation subsystem 441 comprises escrow processing subsystem 601, escrow communications subsystem 603 and escrow database 605; which are communicatively coupled to each other.

Escrow processing subsystem 601 performs relevant processing and analyses within escrow implementation system 441 using information intended for escrow 431 and information intended for escrow 433. The processing and analyses comprises one or more operations. Examples of the one or more operations comprise AI/ML operations, for example:
bias mitigation,
bias detection,
explainability analyses,
data drift detection,
data integrity tests,
data and model robustness detection and mitigation,
privacy tests,
data poisoning tests,
sensitivity analysis,
adversarial de-biasing, and
other techniques for determining the soundness of a model such as an AI/ML model operating in various contexts.

### Examples are Described Below.

In some of the embodiments where escrow implementation subsystem 441 is implemented within AIVS 108, escrow processing subsystem 601 is implemented within validation processing subsystem 230-1 to 230-N.

The result of the processing and analysis performed by escrow implementation system 441 is transmitted to at least one of communicatively coupled parties 435 and 437 as outputs 439. In some embodiments, some of outputs 439 are transmitted to one of communicatively coupled parties 435 and 437 only when authorized to do so.

In at least some cases, at least some first information received from the first party devices 435—and intended for escrow—is not included in any output 439 to the second party devices 437, and at least some second information received from the second party devices 437—and intended for escrow—is not included in any output 439 to the first party devices 435.

To further ensure that either party does not view information that they should not view, in some embodiments, outputs 439 comprise aggregated results from which the information intended for escrow cannot be derived. In yet other embodiments, output 439 comprises anonymized results, so that the information intended for escrow cannot be derived.

In some embodiments, the outputs 439 comprise microapprovals, using generated benchmarks, as previously explained. In yet other embodiments, the escrow processing subsystem 601 implements one or more AI/ML algorithms to automate the process of generating microapprovals or overall approvals, as previously explained.

In the embodiments where parties 435 and 437 are coupled to either network 105 of FIG. 1 or interconnection 233 of FIG. 3 as previously described, the outputs 439 are then transmitted via either network 105 of FIG. 1 or interconnection 233 of FIG. 3.

Escrow communications subsystem 603 performs the task of receiving communications from, and transmitting communications to parties 435 and 437. In some of the embodiments where escrow implementation system 441 is implemented as part of AIVS 108, escrow communications subsystem 603 is implemented using at least one of
communications subsystem 234 of FIG. 3; and
interconnection 233 of FIG. 3.

In some of the embodiments where escrow communications subsystem 603 is implemented using communications subsystem 234, escrow communications subsystem 603 additionally comprises application engine 235 of FIG. 3.

In some embodiments, network isolation measures such as firewall 609 are implemented within escrow communications subsystem 603. The role of these network isolation measures is explained in further detail below.

Escrow database 605 performs the role of storing information within escrow implementation system 441. The information stored by escrow database 605 comprises, for example:
information intended for escrow 431,
information intended for escrow 433,
outputs from analysis 439, and
intermediate results of processing operations performed by escrow processing subsystem 601.

In some of the embodiments where escrow implementation subsystem 441 is implemented within AIVS 108, escrow database 605 is implemented within databases 232 of FIG. 3.

As explained before, there is a need to maintain a separation between parties 435 and 437 so that parties 435 and 437 cannot view the information submitted by the other party.

To maintain this separation, in some embodiments one or more of the following techniques are implemented within escrow implementation system 441, so that each party cannot view the information submitted by the other party, and can only view the information intended for escrow which they submitted:
escrow database 605 is partitioned so that each party can only view the information intended for escrow submitted by that party, and cannot view the information intended for escrow submitted by the other party. For example, party 435 can only view information intended for escrow 431, and cannot view information intended for escrow 433.
escrow processing subsystem 601 is isolated from both parties 435 and 437, that is, both parties 435 and 437 do not have control over the operation of escrow processing subsystem 601. This is achieved by, for example, not granting sufficient privileges to either party 435 or party 437 to control the operation of escrow processing subsystem 601.
the previously mentioned network isolation measures such as firewall 609 are implemented within escrow communications subsystem 603 to ensure that information intended for escrow 431 and information intended for escrow 433 are isolated from each other, and therefore parties 435 and 437 cannot view information submitted by the other party.

In some embodiments, other techniques are employed, including rules-based techniques and policies to ensure separation of the two parties.

In some other embodiments, in addition to not being able to view information intended for escrow submitted by the other party, a party cannot view information intended for escrow which it has submitted. This further strengthens the isolation and neutrality of the escrow implementation system 441.

In some embodiments, escrow implementation system 441 is used to implement a remote escrow service. In yet other embodiments, escrow implementation system 441 is used to implement a neutral internal escrow service.

In some embodiments, the escrow implementation system 441 implements a sensitive feature escrow service using a sensitive feature escrow service subsystem. The sensitive feature escrow service subsystem comprises a fairness engine running on, for example, escrow processing subsystem 601. Party 435 comprises, for example, the development users 101 running development devices 110 as shown in FIG. 1. Information intended for escrow comprising model parameters, test data and test labels are submitted by party 435. Party 437 comprises, for example, the validation users 141 running validation devices 130 as shown in FIG. 1. Information intended for escrow comprising sensitive features are inputted to the escrow service subsystem from party 437. Sensitive features are features which impact the fairness of an AI or ML model, whereby decisions or analyses made based on sensitive features may lead to the AI or ML model returning unfair outcomes.

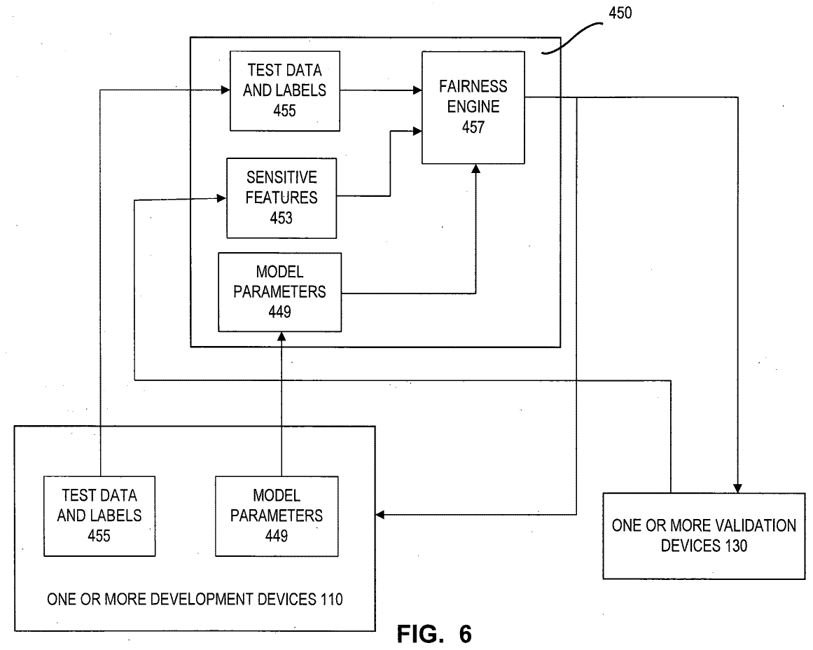

An example embodiment of sensitive feature escrow service subsystem 450 is shown in FIG. 6. In FIG. 6, sensitive feature escrow service subsystem 450 comprises fairness engine 457. Fairness engine 457 runs on, for example, escrow processing subsystem 601 of FIG. 5B.

Following the framework process outlined in FIG. 4, and with reference to the embodiments described in FIGS. 5A, 5B and 6, then as explained above, information intended for escrow comprising test data and test labels 455 are inputted to the escrow service subsystem 450 by development users 101 using the development devices 110 as part of step 403. In some of these embodiments, the information intended for escrow comprises model parameters 449, which are supplied to the escrow service subsystem 450 by the development devices 110 as part of step 403.

As explained before, in some embodiments the escrow implementation system 441 is implemented within AIVS 108, and escrow processing subsystem 601 is implemented within validation processing subsystems 230-1 to 230-N. Then, in some of these embodiments, the information comprising the test data, test labels and model parameters are input to the one or more validation processing subsystems 230-1 to 230-N via networks 105 and communications subsystem 234 within AIVS front end 104 and one or more interconnections 233. In some of these embodiments, the information is input via the communications subsystem 234 and application engine 235. The sensitive features 453 are input to the one or more validation processing subsystems 230-1 to 230-N by validation users 141 running validation devices 130, via the one or more interconnections 233.

In step 404, these test data and labels are evaluated for fairness by the fairness engine 457 using the sensitive features 453 inputted from the validation devices 130. In other embodiments, the model parameters 449 supplied as part of step 403 are used to evaluate the fairness of the model using the fairness engine in step 404. In some of these embodiments, the fairness evaluations are performed using benchmarks built based on the sensitive features 453 inputted from the validation devices 130. An example of the building of such benchmarks and evaluation against the benchmarks is provided in, for example,
Ghosh B, Basu D, Meel KS. “Justicia: A Stochastic SAT Approach to Formally Verify Fairness”, published on May 18, 2021 in Proceedings of the AAAI Conference on Artificial Intelligence 2021 (Vol. 35, No. 9, pp. 7554-7563), and hereinafter referred to as the “Ghosh reference”;
Albarghouthi A, D'Antoni L, Drews S, Nori AV. “Fairsquare: probabilistic verification of program fairness”, published on Oct. 12, 2017 in Proceedings of the ACM on Programming Languages. Vol. 1 (OOPSLA): pp. 1-30, and hereinafter referred to as the “Albarghouthi reference”; and
Bastani O, Zhang X, Solar-Lezama A. “Probabilistic verification of fairness properties via concentration”, published on Oct. 10, 2019 in Proceedings of the ACM on Programming Languages. Vol. 3 (OOPSLA): pp. 1-27, and hereinafter referred to as the “Bastani reference”.

In the embodiments of the sensitive feature escrow service subsystem above, the previously described techniques to ensure separation between the validation users 141 and the development users 110 are utilized. Then, the development team does not have any knowledge of sensitive features 453; and the validation team does not have any knowledge of test data and labels 455, or model parameters 449.

As explained above, in some embodiments, the sensitive feature escrow service is implemented as a remote escrow service. In other embodiments, the sensitive feature escrow service is implemented as an internal escrow service, as also previously explained above.

In some embodiments, the escrow implementation system 441 implements a remote escrow-data-driven adversarial de-biasing service. Similar to above and referring to FIG. 5A, party 435 comprises, for example, the development users 101 running development devices 110 as shown in FIG. 1. Party 437, for example, comprises the validation users 141 running validation devices 130 as shown in FIG. 1.

One of skill in the art would understand that adversarial de-biasing involves optimizing an AI or ML model while simultaneously preventing a jointly trained adversary from predicting a sensitive feature. Further information on adversarial de-biasing is provided in, for example, Zhang B H, Lemoine B, Mitchell M. “Mitigating unwanted biases with adversarial learning” published on Dec. 27, 2018 in Proceedings of the 2018 AAAI/ACM Conference on AI, Ethics, and Society (pp. 335-340), and hereinafter referred to as the “Zhang reference”.

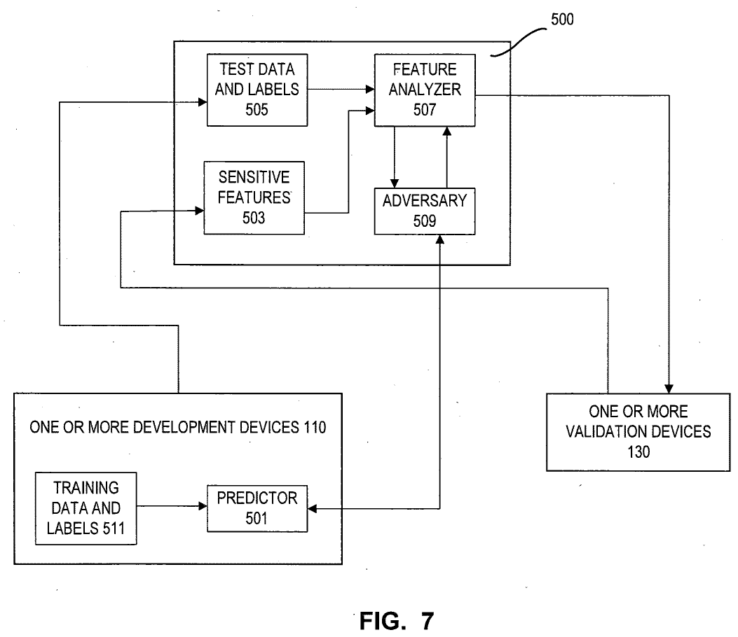

An example embodiment of a subsystem 500 for remote escrow-data-driven adversarial de-biasing is shown in, for example, FIG. 7. Remote escrow-data-driven adversarial de-biasing subsystem 500 runs on, for example, escrow processing subsystem 601 of FIG. 5B.

Training data and labels 511 are used to train predictor model 501 within, for example, AI application 110-4 running on one or more development devices 110. This comprises, for example, modifying predictor weights to minimize a predictor loss function using a gradient-based method. Then following the framework process outlined in FIG. 4, as part of steps 403 and 404 of FIG. 4, one or more outputs from predictor model 501 are then fed as part of information intended for escrow to an adversary model 509 running on remote escrow-data-driven adversarial de-biasing subsystem 500. In some embodiments, the one or more outputs sent to the adversary model depend on a selected measure of fairness. Examples of measures of fairness are described in the Ghosh reference, the Albarghouti reference, the Bastani reference and in Section 3 of the Zhang reference. As is known to one of skill in the art and described in for example, Section 3 of the Zhang reference, the adversary model 509 receives these inputs and operates to minimize an associated adversary loss function by modifying associated adversary weights. The resulting adversary loss function is then fed back to the predictor model 501 to modify the predictor weights. The validation devices are unaware of this exchange of information.

In some of the embodiments which utilize AIVS 108 as previously described, the communication between the predictor and adversary models are performed via networks 105; communications subsystem 234 and application engine 235 within AIVS front end 104 and one or more interconnections 233 as shown in FIGS. 1 and 3. The information is sent within, for example, the incoming signals 250 and outgoing signals 260 as shown in FIG. 3.

As part of steps 403 and 404 of FIG. 4, information intended for escrow comprising test data and labels 505 are input from one or more development devices 110 to system 500. In the embodiments where escrow processing subsystem 601 runs on validation processing subsystems 230-1 to 230-N, this is performed, for example, via networks 105; and communications subsystem 234 and application engine 235 within AIVS front end 104. Information intended for escrow comprising sensitive features 503 are transmitted from the one or more validation devices 130 to system 500.

Then, within system 500, test data and labels 505 and sensitive features 503 are fed to feature analyzer 507. Feature analyzer 507 uses the test labels 505 and the adversary weights from adversary model 509 to predict the sensitive features 503. The predicted values are then compared to the sensitive features 503 to evaluate the fairness.

In the embodiments of the remote escrow-data-driven adversarial de-biasing subsystem above, the previously described techniques to ensure separation between the validation users and the development users are utilized. Then, the development team does not have any knowledge of either the sensitive features 503; and the validation team does not have any knowledge of test data and labels 455, the one or more outputs from predictor model 501, and information returned to the development devices 110 by the adversary model.

In step 405, AIVS back end 106 generates a report based on the analysis performed in step 404, and transmits the report to, for example, application engine 235 of AIVS front end 104. Application engine 235 then communicates the report to the one or more development devices 110 via outgoing signals 260 transmitted by communications subsystem 234 over networks 105. In some embodiments, the report comprises the one or more issued microapprovals. In some embodiments, the report is generated using a template in a markup language such as LaTeX. In some embodiments, the one or more validation processing subsystems 230-1 to 230-N within AIVS back end 106 creates a dashboard and transmits the dashboard to AIVS front end 104, which then transmits the dashboard to the one or more development devices for viewing. In some embodiments, the one or more validation processing subsystems 230-1 to 230-N transmits results via a dashboard to the one or more validation devices 130. This enables the one or more validation devices 130 to receive feedback and perform monitoring and further analyses as necessary. In some embodiments, the outputs from the back end in step 405 is transmitted to both the one or more validation devices 130 and the one or more development devices 110, to enable the validation and development teams to perform further analyses as necessary.

Previously, embodiments were described above for implementation of a sensitive feature escrow service subsystem within the AIVS 108. Then for these embodiments, in step 405, the outputs from the fairness evaluations performed by sensitive feature escrow service fairness engine 457 are transmitted to both the development devices 110 and validation devices 130 to enable analysis to be performed at these devices. The outputs from the fairness evaluations performed above, are analogous to outputs 439 of FIG. 5B. As explained previously, in some embodiments, the outputs comprise aggregated or anonymized data which do not allow for derivation of the information intended for escrow. In yet other embodiments, the outputs comprise microapprovals using generated benchmarks, as previously explained. In yet other embodiments, the fairness engine implements one or more AI/ML algorithms to automate the process of generating microapprovals or overall approvals, as previously explained. This potentially results in advantages of faster model development time, as also previously explained.

Previously, embodiments were described above for the subsystem for remote, escrow-data-driven adversarial de-biasing within the AIVS 108. For these embodiments, in step 405, the outputs from the fairness evaluations performed by the subsystem for remote escrow-data-driven adversarial de-biasing are transmitted to both the development devices 110 and validation devices 130 to enable analysis to be performed at these devices. The outputs from these fairness evaluations performed above, are analogous to outputs 439 of FIG. 5B. As explained previously, in some embodiments, the outputs comprise aggregated or anonymized data which do not allow for derivation of the information intended for escrow. In yet other embodiments, the outputs comprise microapprovals using generated benchmarks, as previously explained. In yet other embodiments, the fairness engine implements one or more AI/ML algorithms to automate the process of generating microapprovals or overall approvals, as previously explained. This potentially results in advantages of faster model development time, as also previously explained.

Although the algorithms described above including those with reference to the foregoing flow charts have been described separately, it should be understood that any two or more of the algorithms disclosed herein can be combined in any combination. Any of the methods, algorithms, implementations, or procedures described herein can include machine-readable instructions for execution by: (a) a processor, (b) a controller, and/or (c) any other suitable processing device. Any algorithm, software, or method disclosed herein can be embodied in software stored on a non-transitory tangible medium such as, for example, a flash memory, a CD-ROM, a floppy disk, a hard drive, a digital versatile disk (DVD), or other memory devices, but persons of ordinary skill in the art will readily appreciate that the entire algorithm and/or parts thereof could alternatively be executed by a device other than a controller and/or embodied in firmware or dedicated hardware in a well known manner (e.g., it may be implemented by an application specific integrated circuit (ASIC), a programmable logic device (PLD), a field programmable logic device (FPLD), discrete logic, etc.). Also, some or all of the machine-readable instructions represented in any flowchart depicted herein can be implemented manually as opposed to automatically by a controller, processor, or similar computing device or machine. Further, although specific algorithms are described with reference to flowcharts depicted herein, persons of ordinary skill in the art will readily appreciate that many other methods of implementing the example machine readable instructions may alternatively be used. For example, the order of execution of the blocks may be changed, and/or some of the blocks described may be changed, eliminated, or combined.

It should be noted that the algorithms illustrated and discussed herein as having various modules which perform particular functions and interact with one another. It should be understood that these modules are merely segregated based on their function for the sake of description and represent computer hardware and/or executable software code which is stored on a computer-readable medium for execution on appropriate computing hardware. The various functions of the different modules and units can be combined or segregated as hardware and/or software stored on a non-transitory computer-readable medium as above as modules in any manner, and can be used separately or in combination.

While particular implementations and applications of the present disclosure have been illustrated and described, it is to be understood that the present disclosure is not limited to the precise construction and compositions disclosed herein and that various modifications, changes, and variations can be apparent from the foregoing descriptions without departing from the spirit and scope of an invention as defined in the appended claims.

### REFERENCES

Each of the following references represent the level of knowledge and skill of one skilled in the art, and the entire contents of each reference is incorporated herein by reference, where permitted:
Supervision and Regulation Letter 11-7: Guidance on Model Risk Management, published Apr. 4, 2011 (Board of Governors of the United States Federal Reserve System)
Ghosh B, Basu D, Meel KS. “Justicia: A Stochastic SAT Approach to Formally Verify Fairness”, published on May 18, 2021 in Proceedings of the AAAI Conference on Artificial Intelligence 2021 (Vol. 35, No. 9, pp. 7554-7563).
Albarghouthi A, D'Antoni L, Drews S, Nori AV. “Fairsquare: probabilistic verification of program fairness”, published on Oct. 12, 2017 in Proceedings of the ACM on Programming Languages. Vol. 1 (OOPSLA): pp. 1-30.
Bastani O, Zhang X, Solar-Lezama A. “Probabilistic verification of fairness properties via concentration”, published on Oct. 10, 2019 in Proceedings of the ACM on Programming Languages. Vol. 3 (OOPSLA): pp. 1-27.
Zhang B H, Lemoine B, Mitchell M. “Mitigating unwanted biases with adversarial learning” published on Dec. 27, 2018 in Proceedings of the 2018 AAAI/ACM Conference on AI, Ethics, and Society (pp. 335-340).

1. A system for artificial intelligence models comprising:
an artificial intelligence validation system coupled to a network, wherein the artificial intelligence validation system comprises
a back end comprising
one or more validation processing subsystems,
a database, further wherein
the validation processing subsystem is communicatively coupled to
the database via one or more interconnections;
a front end comprising
an application engine, and
a communications subsystem, further wherein
the communications subsystem and the application engine are communicatively coupled to the back end via the one or more interconnections,
the communications subsystem is communicatively coupled to the application engine, and
the communications subsystem is communicatively coupled to the network to receive one or more incoming signals from and transmit one or more outgoing signals to the network,
wherein the one or more incoming signals comprise one or more of qualitative and/or quantitative information;
at least one of the communications subsystem and the application engine extracts the quantitative and/or qualitative information within the one or more incoming signals;
the one or more validation processing subsystems receives the qualitative and/or quantitative information from at least one of the communications subsystem and the application engine via the one or more interconnections;
the one or more validation processing subsystems uses at least one of the quantitative and/or qualitative information to perform comparisons to one or more benchmarks;
the one or more validation processing subsystems generates one or more microapprovals based on the comparisons,
wherein the generation of the one or more microapprovals is performed using one or more artificial intelligence or machine learning operations; and
the one or more validation processing subsystems transmits, via the communications subsystem and the application engine, the microapprovals using the one or more outgoing signals.

2. The system of claim 1, further comprising one or more development devices coupled to the network, and the one or more incoming signals, comprising the qualitative and/or quantitative information, are received via the network from at least one of the one or more development devices.

3. The system of claim 2, wherein the qualitative and/or quantitative information are generated at the at least one development device based on user inputs into the respective at least one development device.

4. The system of claim 1, wherein the one or more outgoing signals comprise one or more queries generated by the application engine.

5. The system of claim 1, further wherein one or more validation devices associated with one or more validation users are coupled to the one or more validation processing subsystems.

6. The system of claim 5, wherein the one or more benchmarks are generated by the one or more validation processing subsystems based on inputs provided by the one or more validation devices.

7. The system of claim 1, wherein the quantitative information comprises at least one of
one or more tags, and
metadata; and
the one or more benchmarks are generated using the at least one of
the one or more tags, and
the metadata.

8. The system of any one of claims 1 to 7, wherein the one or more benchmarks are generated in accordance with one or more policies.

9. The system of claim 1, wherein the performing of comparisons to the one or more benchmarks comprises performing an explainability analysis, performing a bias scanning analysis, or performing an analysis to determine conformity to one or more policies.

10-11. (canceled)

12. A method for artificial intelligence comprising:
receiving, by an artificial intelligence validation system, one or more qualitative and/or quantitative information within one or more incoming signals;
extracting, by at least one of a communications subsystem and an application engine within the artificial intelligence validation system, the quantitative and/or qualitative information from the one or more incoming signals;
receiving, by one or more validation processing subsystems within the artificial intelligence validation system, the qualitative and/or quantitative information;
comparing, by the one or more validation processing subsystems, at least one of the quantitative and/or qualitative information to one or more benchmarks,
generating, by the one or more validation processing subsystems, one or more microapprovals based on the comparing, wherein
the generation of the one or more microapprovals is performed using one or more artificial intelligence or machine learning operations; and
transmitting, by the one or more validation processing subsystems, the generated one or more microapprovals.

13. The method of claim 12, wherein the one or more incoming signals are transmitted by at least one development device.

14. The method of claim 13, wherein the qualitative and/or quantitative information are generated based on user inputs into the respective at least one development device.

15. The method of claim 13, wherein the quantitative and/or qualitative information are generated, at the at least one development device, in response to one or more queries.

16. The method of claim 13, wherein the generated one or more microapprovals are transmitted to one or more of:
the at least one development device, and
one or more validation devices.

17. The method of claim 16, wherein the one or more benchmarks are generated by the one or more validation processing subsystems based on inputs supplied from one or more validation devices.

18. The method of claim 12, wherein the quantitative information comprises at least one of
one or more tags, and
metadata; and
the one or more benchmarks are generated using the at least one of
the one or more tags, and
the metadata.

19. The method of claim 12, wherein the one or more benchmarks are generated in accordance with one or more policies.

20. The method claim 12, wherein the comparing comprises performing an explainability analysis, a bias scanning analysis, or an analysis to determine conformity to one or more policies.

21-22. (canceled)

23. A system for providing an escrow service for artificial intelligence (AI) model development and validation, the system comprising:
an artificial intelligence validation system coupled to a network, wherein the artificial intelligence validation system comprises
a back end further comprising
one or more validation processing subsystems, and
a database, further wherein
the one or more validation processing subsystems are communicatively coupled to the database via one or more interconnections,
a front end comprising
an application engine, and
a communications subsystem, further wherein
the communications subsystem and the application engine are communicatively coupled to the back end via the one or more interconnections,
the communications subsystem is communicatively coupled to the application engine, and
the communications subsystem is communicatively coupled to the network to receive one or more incoming signals and transmit one or more outgoing signals from the network;
further wherein
a first information intended for escrow are input to the one or more validation processing subsystems,
a second information intended for escrow are input to the one or more validation processing subsystems,
an analysis is performed by the one or more validation processing subsystems using the first information intended for escrow and the second information intended for escrow, wherein
the analysis comprises one or more artificial intelligence or machine learning operations,
one or more outputs are generated based on the analysis, and
the one or more outputs from the analysis.

24. The system of claim 23, wherein the system further comprises one or more first party devices and one or more second party devices, each of the one or more first and second party devices being coupled to the network or the one or more interconnections, and
the first information is received from the one or more first party devices, and
the second information is received from the one or more second part devices, and
wherein the one or more outputs from the analysis are transmitted to at least one, of the one or more, first party and second party devices.

25-28. (canceled)

29. A method for operating an escrow service to validate an artificial intelligence (AI) model comprising:
receiving from, one or more first party devices, a first information intended for escrow to one or more validation processing subsystems;
receiving from, one or more second party devices, a second information intended for escrow to the one or more validation processing subsystems; and
performing, by the one or more validation processing subsystems, an analysis using the first information intended for escrow and the second information intended for escrow, wherein
the analysis comprises one or more artificial intelligence or machine learning operations,
one or more outputs are generated based on the analysis, and
transmitting the one or more outputs from the analysis to at least one of the one or more first party and second party devices,
wherein at least some first information is not included in any output to the one or more second party devices, and at least some second information is not included in any output to the one or more first party devices.

30-33. (canceled)
